(19) United States
(12) Patent Application Publication
(10) Pub. No.: US 2005/0141834 A1
(43) Pub. Date: Jun. 30, 2005

(54) Optical fiber having sea and islands structure

(75) Inventor: Hidenobu Murofushi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/066,283

(22) Filed: Feb. 28, 2005

Related U.S. Application Data
(63) Continuation of application No. PCT/JP03/10969, filed on Aug. 28, 2003.

(30) Foreign Application Priority Data
Aug. 29, 2002 (JP) 2002-251098

(51) Int. Cl. G02B 6/02

(52) U.S. Cl. 385/123

(57) ABSTRACT

To provide a low attenuation and high bandwidth type optical transmission article. An optical fiber having a sea and islands structure in which a dispersed phase as a low refractive index component is dispersed in a continuous phase as a high refractive index component.

### BACKGROUND OF THE INVENTION

1. Field of the Invention

The present invention relates to an optical transmission article to be used, for example, as an optical fiber, particularly to an optical transmission article having a sea and islands structure, which is excellent in heat resistance, flame retardancy, chemical resistance and solvent resistance and which exhibits a low attenuation and a high bandwidth.

2. Discussion of Background

Optical fiber has excellent characteristics as an optical transmission medium, and heretofore, inorganic glass optical fiber having an excellent optical transmission property over a particularly wide wavelength, has been used. Further, such inorganic glass optical fiber not only is poor in processability and has weak bending stress but also is expensive, and accordingly an optical fiber (optical fiber strand) made of a plastic as a base material has been developed and used practically.

Heretofore, as optical fiber, a stepped refractive index type (SI type) optical fiber is common wherein a high refractive index core material is enclosed with a clad (sheath) material having a lower refractive index to form a core/clad structure by the combination of materials having different refractive indices. Many plastic optical fibers of such a structure have been proposed, and some have been practically employed. They comprise a core layer made of a polymer having good light transmittance such as an acrylic polymer as represented by polymethyl methacrylate, a polycarbonate, a polystyrene or norbornene, as a base material, and a sheath (clad) layer made of e.g. a substantially transparent fluoropolymer having a refractive index lower than the core layer, as a base material, as basic constituting units. Further, JP-A-2-244007 proposes use of a fluororesin for each of the core layer and the clad layer.

As optical fiber, as well as the above-mentioned stepped refractive index type optical fiber, a refractive index distribution type (GI type) optical fiber is also known wherein the refractive index is attenuated by having the material distributed in a radial direction from the axial core to the circumferential direction (e.g. “Chemistry and Industry”, Vol. 45, No. 7, 1261-1264 (1992), JP-A-5-173026, WO94/04949, WO94/15005, etc). Further, JP-A-5-241036 proposes a single mode (SM) plastic optical fiber which transmits only light of a single or specific mode. Further, JP-A-9-33737 proposes a multi-core plastic optical fiber comprising a clad resin and at least seven cores having a diameter of from 50 to 200 μm, made of a resin having a refractive index higher than the clad resin, embedded in the clad resin.

Further, an optical fiber (holey fiber) having a structure containing pores, is also known. For example, an optical fiber having air incorporated in a single material of silica glass, is known as a total reflection waveguide type holey fiber wherein light is wave-guided by total reflection by the presence of low refractive index pores.

In recent years, attention has been drawn to a photonic crystal fiber wherein such pores extending in parallel with each other in a long axis direction, are periodically arranged to constitute a photonic crystal structure. One of photonic crystal fibers is a total reflection type holey fiber which has a core/clad structure, wherein pores are present in the clad so that the effective refractive index of the clad is lower than the refractive index of the core portion, and light is wave-guided by total reflection.

Further, among photonic crystal fibers, as one showing particularly large wavelength distribution, attention has been drawn to a waveguide principle wherein the core portion constitutes a defect in the periodical arrangement of pores constituting such a photonic crystal structure, and the photonic crystal fiber exhibits a photonic band gap (PBG) against the frequency of light wave-guided through the core portion.

With a fiber utilizing such PBG as the waveguide principle, light having the frequency and transmission constant belonging to PBG will be exponentially attenuated in the clad and can not have a large amplitude, but can have a large amplitude in the core having a defect in the periodicity, whereby the light will be localized at the core. With such PBG fiber, the core may have a hollow structure so long as the periodicity of pores be ruptured, and it is substantially different in this respect from the conventional high refractive index core structure.

A photonic crystal fiber is capable of accomplishing a broad band single mode operation depending upon the size, number and arrangement of pores.

As a holey fiber including such a photonic crystal fiber, an inorganic glass type quartz fiber is known, and as its production method, a method (1) is available wherein a columnar body composed mainly of SiO₂ is prepared, then many slender holes extending through in the long axis direction around the axial core portion of the columnar body are formed to prepare a preform having a solid-core structure, and such a preform is stretched (drawn) in the long axis direction to reduce the pore size thereby to obtain an optical fiber.

Further, a method (2) has also been proposed in which many SiO₂ capillaries are bundled in the most densely packed state, and the outer surfaces of capillaries adjacent to one another are fused and integrated to obtain a preform, and such a preform is drawn to produce a photonic crystal fiber (JP-A-2002-97034).

As mentioned above, a plastic optical fiber has characteristics which an inorganic glass optical fiber does not have, however, a conventional stepped refractive index type plastic optical fiber is not practical in view of narrow bandwidth. In JP-A-9-33737, it has been tried to improve the bandwidth while maintaining the amount of incident light, by reducing the difference in refractive index between the core material and the clad material, and bundling cores having a small core diameter so as to compensate for the decreased bending loss, however, a high speed transmission of at least 1 GHz for 100 m has not been achieved yet. Further, a refractive index distribution type plastic optical fiber is not practical as an optical fiber for communication in view of large attenuation in the case of near infrared light. Further, a plastic optical fiber can be used only in a specific wavelength region, due to light absorption resulting from vibration of the C—H bond and deformation vibration, that is, it can not be used in visible light (500 to 700 nm) and near infrared light (700 to 1,600 nm) regions, and its use is limited.

Further, by the method (1) for producing a holey fiber including a photonic crystal fiber, since many slender holes are formed close to one another in a columnar body, the wall partitioning between adjacent slender holes is extremely thin and is likely to break during the processing, and thus preparation of the preform is extremely difficult. Further, by the above production method (2), it is difficult to handle the slender capillaries and to maintain the cleanness, thereby it is extremely difficult to fuse and integrate many capillaries bundled in the most densely packed state while maintaining such a form. Further, since the fiber has many pores, dust or water is likely to get into the gap, and the packing ratio per fiber sectional area is low, whereby the fiber strength tends to be weak.

Further, a conventional plastic optical fiber is not satisfactory in view of mechanical strength, heat resistance, moisture resistance, chemical resistance and incombustibility for a specific purpose of use.

It is an object of the present invention to provide an optical transmission article capable of being used as an optical fiber, having mechanical strength, heat resistance, moisture resistance, chemical resistance and incombustibility required for e.g. LAN, housing complexes, medical equipments, automobiles and office automation and electric household appliances, which have not been achieved by a plastic optical fiber composed mainly of a polymer such as an acrylic polymer as represented by polymethyl methacrylate, a polystyrene or a polycarbonate. Further, it is an object of the present invention to provide an optical transmission article capable of being used as a low attenuation and high bandwidth type optical fiber, which can be used in visible light (500 to 700 nm) and near infrared light (700 to 1,600 nm) regions, which has mechanical strength which an optical fiber containing pores (a holey fiber including a photonic crystal fiber) does not have, and which can impart ultra-high speed transmission properties by making the core portion under single mode transmission conditions as the case requires, which have not been achieved by a plastic optical fiber composed mainly of a polymer such as an acrylic polymer, a polycarbonate or norbornene.

### SUMMARY OF THE INVENTION

In order to achieve the above object, the present invention provides an optical transmission article having a sea and islands structure in which a low refractive index dispersed phase is dispersed in a high refractive index continuous phase.

In the cross sectional shape of the optical transmission article, it is preferred that the low refractive index dispersed phase is arranged to have a periodicity forming an optical waveguide.

In the optical transmission article of the present invention, it is preferred that each of a component constituting the high refractive index continuous phase and a component constituting the low refractive index dispersed phase is a polymer of an organic compound.

It is preferred that the component constituting the high refractive index continuous phase is made of an amorphous fluoropolymer (a) having substantially no C—H bond, and the component constituting the low refractive index dispersed phase is made of a fluoropolymer (b) having a refractive index lower than the fluoropolymer (a) by at least 0.001.

The fluoropolymer (a) preferably contains a fluorinated cyclic structure.

The fluorinated cyclic structure is preferably a fluorinated alicyclic structure which may contain a ring member ether bond.

In the optical transmission article of the present invention, the fluoropolymer containing a fluorinated cyclic structure preferably has the fluorinated cyclic structure in its main chain.

In the optical transmission article of the present invention, it is preferred that each of the fluoropolymers (a) and (b) is an amorphous fluoropolymer having substantially no C—H bond and having a fluorinated alicyclic structure which may contain an ether bond in its main chain.

The present invention provides a perform to be used for producing the above optical transmission article having sea and islands structure, which has a sea and islands structure in which a polymer of an organic compound as a low refractive index component is dispersed in a continuous body made of a polymer of an organic compound as a high refractive index component, and the polymer of an organic compound as a low refractive index component extends in the longitudinal direction in the continuous body. It is preferably a preform from which a stretched molded product (optical transmission article) having homogeneous diametric cross sections is obtained after stretching.

The present invention further provides a method for producing the optical transmission article having a sea and islands structure of the present invention or its perform, which comprises disposing a polymer of an organic compound as a low refractive index component in the form of a preliminarily divided strand, in a tube made of a polymer of an organic compound as a high refractive index component, followed by co-spinning.

The present invention further provides a method for producing the optical transmission article having a sea and islands structure of the present invention or its perform, which comprises splitting and forming into strands in an extrusion die a uniformly molten polymer of an organic compound as a low refractive index component, supplying a polymer of an organic compound as a high refractive index component around the periphery thereof, so that the organic polymer as a high refractive index component is applied around the outer periphery of the organic polymer as a low refractive index component, and extruding them through a common nozzle.

The present invention further provides an optical fiber cord comprising the above optical transmission article and at least one covering applied on the optical transmission article.

The present invention further provides an optical fiber cable comprising a continuous body made of a thermoplastic resin, having pores extending in the longitudinal direction in the inside thereof and having a tension member embedded therein, and the above optical fiber cord accommodated in the pores in the continuous body.

The present invention further provides a bundled fiber having a plurality of the above optical fiber cords bundled.

### BRIEF DESCRIPTION OF THE DRAWINGS

FIG. 1 is a cross-sectional view illustrating an optical transmission article having a sea and islands structure in which a dispersed phase is randomly dispersed in a continuous phase.

FIG. 2 is a cross-sectional view illustrating an optical transmission article having a sea and islands structure in which a dispersed phase is periodically dispersed over the whole continuous phase.

FIG. 3 is a cross-sectional view illustrating an optical transmission article having a sea and islands structure in which a dispersed phase is periodically dispersed in a continuous phase as an embodiment different from FIG. 2, and the dispersed phase is arranged concentrically relative to the center axis of the optical transmission article.

FIG. 4 is a cross-sectional view illustrating an optical transmission article utilizing a photonic band gap as the waveguide principle, wherein a defect is present in periodically arranged dispersed phases having a photonic crystal structure.

FIG. 5 is a cross-sectional view illustrating a plastic optical fiber having a sea and islands structure of the present invention produced in Example 1.

FIG. 6 is a cross-sectional view illustrating a plastic optical fiber having a sea and islands structure of the present invention produced in Example 2.

FIG. 7 is a cross-sectional view illustrating a plastic optical fiber having a single mode duplex sea and islands structure of the present invention prepared in Example 4 or 5.

### MEANINGS OF SYMBOLS

1: optical transmission article (optical fiber), 2: continuous phase (sea), 3: dispersed phase (island)

### DETAILED DESCRIPTION OF THE PREFERRED EMBODIMENTS

Now, the present invention will be described in detail.

In the present invention, the optical transmission article may specifically be, for example, an optical fiber, an optical waveguide, a switch or a rod lens.

With respect to the optical transmission article of the present invention, in the idea of the above holey fiber including a photonic crystal fiber, instead of providing pores, in a continuous phase, a substance (dispersed phase) having a refractive index lower than a substance constituting the continuous phase is dispersed to achieve a sea and islands structure, thereby to make the optical transmission article function optically similarly to a holey fiber including a photonic crystal fiber, and at the same time, no pores are present in the fiber, thus inclusion of e.g. dust or moisture is prevented, and the fiber strength is increased also.

With respect to the optical transmission article of the present invention, so long as it has the above sea and islands structure, the optical waveguide principle may, for example, be a total reflection type, a stepped refractive index type or one utilizing PBG as the waveguide principle, and is not particularly limited.

Further, the number, shape or arrangement of dispersed phases, the size of the optical transmission article, such as the diameter of the optical fiber strand, etc. are also not particularly limited and may suitably be designed depending upon the purpose of use of the optical transmission article.

Accordingly, in the case where the optical waveguide principle is a total reflection type, the dispersed phase may be dispersed randomly in the continuous phase. FIG. 1 is a cross-sectional view illustrating one example of the optical transmission article of the present invention. In FIG. 1, the optical transmission article 1 is a total reflection type optical transmission article in which dispersed phases 3 are randomly dispersed in a continuous phase 2. However, in the present invention, in the cross sectional shape of the optical transmission article, the dispersed phases are dispersed preferably to have a periodicity forming an optical waveguide. Namely, in the optical transmission article of the present invention, the dispersed phases have the similar role to the pores in a holey fiber including a photonic crystal fiber, and preferably have periodicity which the pores have in the cross sectional shape of such an optical fiber.

Specific examples of the periodicity forming such an optical waveguide are shown below with reference to Figs.

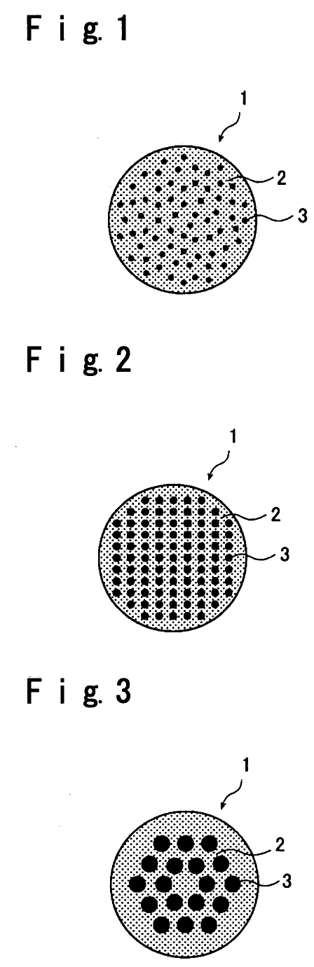

FIGS. 2 and 3 are diametric cross-sectional views illustrating an optical transmission article in which dispersed phases 2 are periodically arranged over the whole continuous phase 3 to form a photonic crystal structure in the diametrical cross section of the optical transmission article 1. In the optical transmission article 1 as shown in FIG. 2 or 3, light is transmitted by the waveguide principle of a total reflection type. In the case of such a total reflection type optical transmission article 1, the dispersed phases 3 are not necessarily arranged strictly periodically, and may be arranged randomly to a certain extent.

Further, the waveguide principle may be one employing PBG wherein in the periodically arranged photonic crystal structure, the dispersed phases have a defect which ruptures the structure, so that a photonic band gap (PBG) is exhibited against light which passes through the defect.

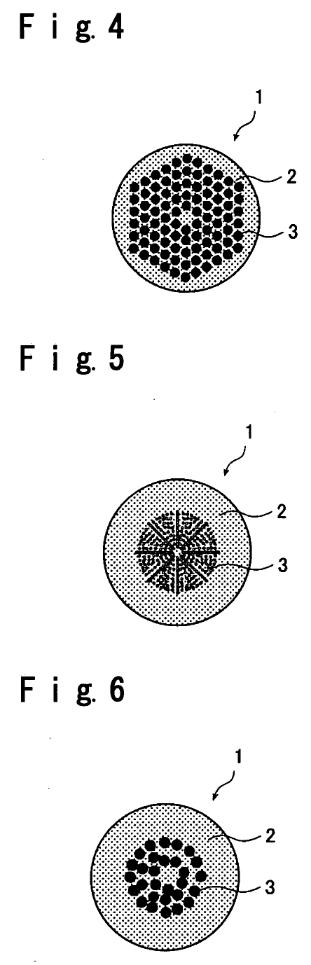

An embodiment utilizing PBG as the waveguide principle, is shown in FIG. 4. In the optical transmission article 1 as shown in FIG. 4, dispersed phases 3 are periodically arranged to form a honeycomb structure, thereby to form a photonic crystal structure. The center portion of the honeycomb structure is constituted by the continuous phase 2, not by the dispersed phase 3. By such a constitution, the continuous phase 2 at the center portion of the honeycomb structure constitutes a defect which ruptures the periodicity in the structure.

In the optical transmission article of the present invention, a component constituting the high refractive index continuous phase and a component constituting the low refractive index dispersed phase are not particularly limited so long as the difference in refractive index between them is preferably at least 0.001 and they are suitable materials as an optical transmission article. Accordingly, they may be two types of inorganic glass with a difference in refractive index therebetween of at least 0.001. However, they are preferably two polymers of organic compounds with a difference in refractive index therebetween of at lest 0.001, and such organic compound polymers widely include polymers of organic compounds to be employed in the field of optical transmission articles. The polymer of an organic compound may, for example, be an acrylic polymer as represented by polymethyl methacrylate, a polystyrene, a polycarbonate, norbornene or a fluoropolymer having part or all of the C—H bonds in an organic compound polymer substituted by C—F bonds. In the present invention, the refractive index means a refractive index against sodium D-lines.

Further, as a result of extensive studies over the above problems, the present inventor has first found that a fluoropolymer having C—H bonds substituted by C—F bonds (i.e. carbon-fluorine bonds) is most suitable so as to impart heat resistance, moisture resistance, chemical resistance and incombustibility and to eliminate C—H bonds (i.e. carbon-hydrogen bonds) which undergo light absorption by near infrared light.

Accordingly, in the optical transmission article of the present invention, the continuous phase and the dispersed phase are preferably made of an amorphous fluoropolymer having substantially no C—H bond.

In the present invention, the fluoropolymer is not particularly limited so long as it is an amorphous fluoropolymer having substantially no C—H bond. However, it is preferably one having a fluorinated cyclic structure. The fluorinated cyclic structure may specifically be, for example, a fluorinated alicyclic structure which may contain a ring member ether bond (hereinafter sometimes referred to simply as a fluorinated alicyclic structure), a fluorinated imide cyclic structure, a fluorinated triazine cyclic structure or a fluorinated aromatic cyclic structure. Among the above fluorinated cyclic structures, a fluorinated alicyclic structure which may contain a ring member ether bond, or a fluorinated polyimide cyclic structure, is preferred, and the former is more preferred.

Further, a fluoropolymer having such a fluorinated cyclic structure in its main chain, is particularly preferred. Further preferred is one which is melt moldable, wherein the main chain-constituting unit containing such a cyclic structure substantially forms a linear structure. Particularly preferred is a fluoropolymer having a fluorinated alicyclic structure in its main chain.

Now, a fluoropolymer having a fluorinated alicyclic structure in its main chain will be described in detail as a particularly preferred fluoropolymer.

The fluoropolymer having a fluorinated alicyclic structure in its main chain is a fluoropolymer, of which the main chain is a chain of carbon atoms and which has a fluorinated alicyclic structure in its main chain.

“Having a fluorinated alicyclic structure in its main chain” means to have a structure wherein at least one carbon atom constituting the alicyclic ring is the carbon atom in the carbon chain constituting the main chain, and a fluorine atom or a fluorine-containing group is bonded to at least part of carbon atoms constituting the alicyclic ring.

The following structures may, for example, be mentioned as a constituting unit of the main chain having a fluorinated alicyclic structure as a preferred embodiment of the fluoropolymer in the present invention.

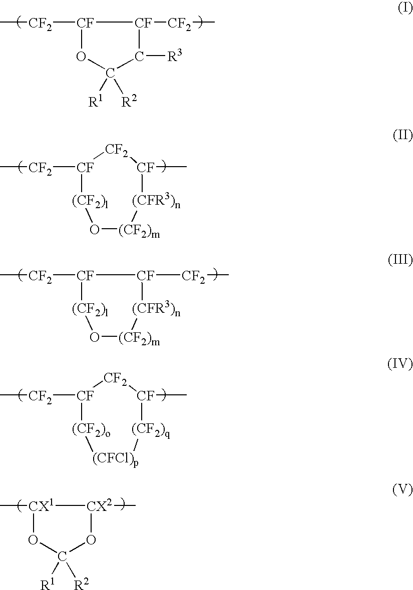

In the above formulae, 1 is from 0 to 5, m is from 0 to 4, n is from 0 to 1, 1+m+n is from 1 to 6, each of o, p and q which are independent of one another, is from 0 to 5, o+p+q is from 1 to 6, each of R¹, R² and R³ which are independent of one another, is F, Cl, CF₃, C₂F₅, C₃F₇ or OCF₃, and each of X¹ and X² which are independent of each other, is F, Cl or CF₃.

As the polymer having a fluorinated alicyclic structure, preferred is specifically \mathring{1} a polymer obtained by polymerizing a monomer having a fluorinated alicyclic structure (a monomer having a polymerizable double bond between a carbon atom constituting the ring and a carbon atom not constituting the ring, or a monomer having a polymerizable double bond between two carbon atoms constituting the ring), or \mathring{2} a polymer having a fluorinated alicyclic structure in its main chain, obtained by cyclopolymerization of a fluorinated monomer having at least two polymerizable double bonds.

The above monomer having a fluorinated alicyclic structure is preferably a monomer having one polymerizable double bond, and the above cyclopolymerizable fluorinated monomer is preferably a monomer having two polymerizable double bonds and having no fluorinated alicyclic structure.

Here, a copolymerizable monomer other than a fluorinated monomer cyclopolymerizable with a monomer having a fluorinated alicyclic structure will hereinafter be referred to as “another radical polymerizable monomer”.

The carbon atoms constituting the main chain of the fluoropolymer are constituted by the two carbon atoms of the polymerizable double bond of the monomer. Accordingly, with a monomer having a fluorinated alicyclic structure having one polymerizable double bond, one or each carbon atom of the two carbon atoms constituting the polymerizable double bond will be the atom constituting the alicyclic ring. With the fluorinated monomer having no alicyclic ring and having two polymerizable double bonds, one carbon atom of one polymerizable double bond and one carbon atom of the other polymerizable double bond will be bonded to form a ring. An alicyclic ring will be formed by the bonded two carbon atoms and atoms present between them (excluding atoms in a side chain), and in a case where an etheric oxygen atom is present between the two polymerizable double bonds, a fluorinated aliphatic ether cyclic structure will be formed.

The polymer having a fluorinated alicyclic structure in its main chain obtained by polymerizing a monomer having a fluorinated alicyclic structure, can be obtained by polymerizing a monomer having a fluorinated alicyclic structure, such as a perfluorodioxol having a fluorine or a fluorinated alkyl group such as a trifluoromethyl group, a pentafluoroethyl group or a heptafluoropropyl group, on a dioxol ring member carbon of e.g. perfluoro(2,2-dimethyl-1,3-dioxol) (simply referred to as PDD), perfluoro(2-methyl-1,3-dioxol), perfluoro(2-ethyl-2-propyl-1,3-dioxol) or perfluoro(2,2-dimethyl-4-methyl-1,3-dioxol), perfluoro(4-methyl-2-methylene-1,3-dioxolane) (simply referred to as MMD), or perfluoro(2-methyl-1,4-dioxin).

Further, a polymer having a fluorinated alicyclic structure in its main chain obtained by copolymerizing such a monomer with another radical polymerizable monomer containing no C—H bond, may also be used. If the proportion of polymerized units of another radical polymerizable monomer becomes large, the light transmittance of the fluoropolymer may sometimes decrease. Accordingly, as the fluoropolymer, preferred is a homopolymer of the monomer having a fluorinated alicyclic structure or a copolymer wherein the proportion of polymerized units of such a monomer is at least 70 mol %.

As another radical polymerizable monomer containing no C—H bond, tetrafluoroethylene, chlorotrifluoroethylene or perfluoro(methyl vinyl ether) may, for example, be mentioned.

As a commercially available amorphous fluoropolymer having substantially no C—H bond of this type, the above-mentioned perfluoro-2,2-dimethyl-1,3-dioxol polymer (Teflon AF, tradename, manufactured by Du Pont), or perfluoro-4-methyl-1,3-dioxol polymer (HYFLON AD, tradename, manufactured by Ausimont) may, for example, be mentioned.

Further, the polymer having a fluorinated alicyclic structure in its main chain obtained by cyclic polymerization of a fluorinated monomer having at least two polymerizable double bonds, is known, for example, by JP-A-63-238111, JP-A-63-238115, etc. Namely, a polymer having a fluorinated alicyclic structure in its main chain may be obtained by cyclic polymerization of a monomer such as perfluoro(3-oxa-1,5-hexadiene) or perfluoro(3-oxa-1,6-heptadiene) (simply referred to as PBVE), or by copolymerizing such a monomer with another radical polymerization monomer containing no C—H bond, such as tetrafluoroethylene, chlorotrifluoroethylene or perfluoro(methyl vinyl ether). By the above cyclic polymerization of PBVE, a polymerized unit having a 5-membered cyclic ether structure in its main chain, as shown in the above formula (1) will be formed by bonding of carbons at 2,6-positions.

Further, as the fluorinated monomer having at least two polymerizable double bonds, in addition to those mentioned above, a monomer having a substituent on a saturated carbon of PBVE may, for example, be preferred. Specifically, perfluoro(4-methyl-3-oxa-1,6-heptadiene) (simply referred to as PBVE-4M), perfluoro(4-chloro-3-oxa-1,6-heptadiene) (simply referred to as PBVE-4CL), perfluoro(5-methoxy-3-oxa-1,6-heptadiene) (simply referred to as PBVE-5MO) or perfluoro(5-methyl-3-oxa-1,6-heptadiene) may, for example, be preferred. If the proportion of polymerized units of another radical polymerizable monomer becomes large, the light transmittance of the fluoropolymer may sometimes decrease. Accordingly, as the fluoropolymer, preferred is a homopolymer of a fluorinated monomer having at least two polymerizable double bonds, or a copolymer wherein the proportion of polymerized units of such a monomer is at least 40 mol %.

As a commercial product of such an amorphous fluoropolymer having substantially no C—H bond, “CYTOP” (manufactured by Asahi Glass Company, Limited) is available.

Further, it is possible to obtain a fluoropolymer having a fluorinated alicyclic structure in its main chain also by copolymerizing a monomer having a fluorinated alicyclic structure such as perfluoro(2,2-dimethyl-1,3-dioxol) with a fluorinated monomer having at least two polymerizable double bonds such as perfluoro(3-oxa-1,5-hexadiene) or perfluoro(3-oxa-1,6-heptadiene) (PBVE). Also in this case, depending upon the combination, there may be a case where the light transmittance decreases. Accordingly, preferred is a copolymer wherein the proportion of polymerized units of a fluorinated monomer having at least two polymerizable double bonds, is at least 30 mol %.

The polymer having a fluorinated alicyclic structure is preferably a polymer having the cyclic structure in its main chain. However, one containing at least 20 mol %, preferably at least 40 mol %, of polymerized units having a cyclic structure, based on the total polymerized units, is preferred from the viewpoint of the transparency, mechanical properties, etc.

Further, the polymer having a fluorinated alicyclic structure is preferably a perfluoropolymer. Namely, preferred is a polymer wherein all hydrogen atoms bonded to carbon atoms are substituted by fluorine atoms.

However, a part of fluorine atoms of the perfluoropolymer may be substituted by atoms other than hydrogen atoms, such as chlorine atoms or heavy hydrogen atoms. Presence of chlorine atoms brings about an effect to increase the refractive index of the polymer, and accordingly, a polymer having chlorine atoms is particularly useful as the fluoropolymer.

The above fluoropolymer preferably has a sufficiently high molecular weight so that the optical transmission article has heat resistance, it is hardly softened even when exposed at a high temperature, and the light transmission performance will not decrease. Further, the molecular weight of the fluoropolymer to provide such characteristics has a melt moldable level of the molecular weight as its upper limit. However, when it is represented by an intrinsic viscosity [η] measured in perfluoro(2-butyltetrahydrofuran) (PBTHF) at 30° C., it is usually preferably at a level of from 0.1 to 1 dl/g, more preferably at a level of from 0.2 to 0.5 dl/g. Here, the number average molecular weight corresponding to the intrinsic viscosity is usually at a level of from 1×10⁴ to 5×10⁶, preferably at a level of from 5×10⁴ to 1×10⁶.

Further, in order to secure the processability during the melt spinning of the above fluoropolymer or during the stretching of the preform, the melt viscosity of the fluoropolymer when the fluoropolymer is melted at a temperature of from 200 to 300° C., is preferably at a level of from 1×10² to 1×10⁵ Pa.s.

The fluoropolymer having the above-described fluorinated alicyclic structure is particularly preferred for such a reason that as compared with a fluoropolymer having the after-mentioned fluorinated imide cyclic structure, fluorinated triazine cyclic structure or fluorinated aromatic cyclic structure, even if formed into a fiber by melt spinning or heat stretching, the polymer molecules can hardly be aligned, whereby light scattering hardly takes place. Especially preferred is a fluoropolymer having a fluorinated aliphatic ether cyclic structure.

The above-mentioned fluoropolymer having a fluorinated alicyclic structure in its main chain is a preferred fluoropolymer of the present invention. However, as mentioned above, the fluoropolymer of the present invention is not limited thereto.

For example, it is possible to use an amorphous fluoropolymer having a fluorinated cyclic structure other than the fluorinated alicyclic structure in its main chain, having substantially no C—H bond, as disclosed in JP-A-8-5848. Specifically, it is possible to use an amorphous fluoropolymer having a fluorinated cyclic structure such as a fluorinated imide cyclic structure, fluorinated triazine cyclic structure or fluorinated aromatic cyclic structure, in its main chain. The melt viscosity or the molecular weight of such a polymer is preferably within the same range as the one of the above-mentioned fluoropolymer having a fluorinated alicyclic structure in its main chain.

As the fluoropolymer having a fluorinated imide cyclic structure in its main chain, as a preferred fluoropolymer of the present invention, ones having repeating units represented by the following formulae may specifically be exemplified. 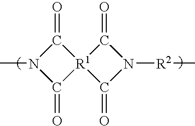
(in the above formula, R¹ is selected from the following: 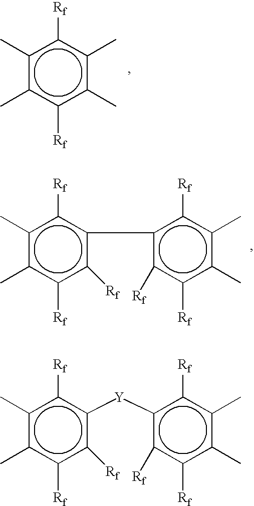
R² is selected from the following:

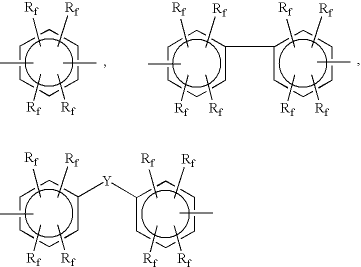

Here, R_{f} is selected from a fluorine atom, a perfluoroalkyl group, a perfluoroaryl group, a perfluoroalkoxy group and a perfluorophenoxy group, and they may be the same or different. Y is selected from the following:
—O—, —CO—, —SO₂—, —S—, —R′_{f}—,
OR′_{f}ᵣ, R′_{f}O_{f}, OR′_{f}Oᵣ,
SR′_{f}ᵣ, R′_{f}Sᵣ, SR′_{f}Sᵣ,
SR′_{f}Oᵣ, OR′_{f}Sᵣ

Here, R′_{f} is selected from a perfluoroalkylene group, and a perfluoroarylene group, and they may be the same or different. r is from 1 to 10. Y and two R_{f} may form a ring together with carbon, and in such a case, the ring may be a saturated ring or an unsaturated ring.)

Further, in the present invention, the fluoropolymer having a fluorinated aromatic cyclic structure may be a fluorinated product of a polymer having an aromatic ring in a side chain or in the main chain of e.g. polystyrene, polycarbonate or polyester. Such a product may be a perfluoropolymer having entirely fluorinated or may be one having a fluorinated residue substituted by chlorine. Further, it may have e.g. a trifluoromethane substituent.

Further, fluorine atoms in the fluoropolymer may partially be substituted by chlorine atoms in order to increase the refractive index. Further, a substance to increase a refractive index may be incorporated to the fluoropolymer of the present invention, but it is preferred that the molding material of the present invention contains substantially no C—H bond as a whole.

In the foregoing, the fluoropolymer constituting the continuous phase and the dispersed phase of the optical transmission article has been described. However, in the present invention, the above polymer as preliminarily polymerized, may be used as the molding material, or a polymerizable monomer capable of forming the above fluoropolymer may be used and polymerized at the time of molding.

Further, preferred components constituting the continuous phase and the dispersed phase of the present invention are amorphous fluoropolymers having substantially no C—H bond, and the amorphous phase is required to have a refractive index lower than the continuous phase by at least 0.001, and thus the fluoropolymer constituting the dispersed phase may contain a small amount of hydrogen atoms. However, from such reasons that the presence of hydrogen atoms may cause absorption of transmitted light, and the presence of hydrogen atoms tends to increase the refractive index of the polymer as compared with fluorine atoms, it is preferred that the fluoropolymer constituting the dispersed phase is also a polymer having substantially no hydrogen atom.

In the present invention, the production method is not particularly limited so long as an optical transmission article having the above-mentioned sea and islands structure can be obtained preferably by using the above fluoropolymers.

Accordingly, in the present invention, an optical transmission article having a sea and islands structure may be directly produced, or an optical transmission article having a desired diameter may be produced by producing a preform having a sea and islands structure, in which a polymer of an organic compound as a low refractive index component is dispersed in a continuous body made of a polymer of an organic compound as a high refractive index component, and the polymer of an organic compound as a low refractive index component extends in a longitudinal direction in the continuous body, and melt spinning the preform. Accordingly, the present invention can also provide a preform having the above-mentioned sea and islands structure.

In the optical transmission article or the preform having a sea and islands structure of the present invention, more specifically, in the optical transmission article or the preform in which each of the continuous phase and the dispersed phase constituting the sea and islands structure is made of a polymer of an organic compound, as a means of forming the sea and islands structure by dispersing the dispersed phase in the continuous phase, melt spinning or extrusion molding may be employed.

For example, a low refractive index organic compound polymer (island material) in the form of a preliminarily divided strand is disposed in a tube prepared by a high refractive index organic compound polymer (sea material), followed by co-spinning, to form a sea and islands structure.

Otherwise, a uniformly molten low refractive index organic compound polymer (sea material) is split and formed into strands in an extrusion die, then a high refractive index organic compound polymer (sea material) is supplied around the periphery thereof, so that the high refractive index organic compound polymer is applied around the outer periphery of the low refractive index organic compound polymer, and further, they are extruded through a common nozzle, to form a sea and islands structure.

In accordance with the procedure of the present invention, an optical fiber strand having a sea and islands structure can be obtained directly or by melt spinning a preform. The optical fiber strand thus obtained is used usually as an optical fiber cord by applying a covering of e.g. a thermoplastic resin. The covering may optionally be selected from materials commonly used as a covering for an optical fiber strand, for example, thermoplastic resins such as a polyethylene, polyvinyl chloride, polymethyl methacrylate (PMMA) and an ethylene/tetrafluoroethylene type copolymer. Usually, a plurality of, for example two, such optical fiber cable cords are accommodated in another covering in the form of a continuous body having a partitioning spacer and having pores to accommodate the optical fiber cable cords, and used as an optical fiber cable. In such a covering in the form of a continuous body, usually a tension member to prevent the elongation in tension of the optical fiber is embedded. The tension member may optionally be selected from materials commonly used for this purpose, such as a metal wire, a wire such as a FRP wire, or highly rigid continuous fiber such as aramid continuous fiber. Further, a plurality of optical fiber cords comprising an optical fiber strand and a covering applied to the optical fiber strand, may be bundled to form a bundled fiber. Such a bundled fiber includes one comprising a plurality of optical fiber cords bundled in a circular form, and a multi-core tape core wire comprising a plurality of optical fiber cords arranged in parallel as well. In a bundled fiber, another covering is further formed to cover the plurality of optical fiber cords bundled. Further, in such a bundled fiber, a tension member or a cushioning material such as thread, string, paper or plastic is usually disposed in the air gap among the optical fiber cords. An optical fiber is obtained in such a manner. However, the present invention is not limited thereto, and it can be applied to an optical waveguide, an optical switch, a rod lens, etc.

The optical transmission article of the present invention is made of fluoropolymers preferably having substantially no C—H bond, and thus it will not be eroded by an acidic chemical such as sulfuric acid or hydrochloric acid or by an alkaline chemical such as sodium hydroxide. Further, it will not be eroded by an organic solvent such as toluene, benzene or acetone, and thus it may be used in a bad environment such as in a sewerage piping or in a plant in which oil flies during operation. Further, it has a sea and islands structure in which the dispersed phase is dispersed in the continuous phase, and thus its bending loss is reduced, and it can be used also for a moving part of e.g. a robot which is frequently bent.

Further, with respect to the optical fiber having a sea and islands structure of the present invention, by making light transmission at a portion of the continuous phase (core portion) surrounded by the dispersed phase be in a single mode by controlling the sea and islands structure, it becomes possible to achieve ultrawideband of from 3 to 4 GHz·km, and the attenuation at a wavelength of from 650 to 1,600 nm for 1,000 m can be made at most 50 dB. Particularly with a fluoropolymer having an alicyclic structure in its main chain, the attenuation at the same wavelength for 1,000 m can be made at most 20 dB. A attenuation of such a low level at a relatively long wavelength of from 700 to 1,600 nm is very advantageous. Namely, it is easily connected with a quartz optical fiber since the same wavelength as for the quartz optical fiber can be employed, and further, the light source can be selected from a wide range as compared with a conventional plastic optical fiber for which a wavelength shorter than 650 nm has to-be employed.

The optical fiber having a sea and islands structure of the present invention can be utilized in various fields, such as LAN in public facilities such as subscriber communication wire, LAN in plants, LAN in hospitals, LAN in schools or LAN in sewerage piping, medical equipment, floor cable, power line monitoring communication line, application to automobiles, monitor image transmission of electronic car driving conditions, application to communication in oceangoing large ship, data transmission in aircraft, image transmission which requires high speed and high bandwidth for e.g. amusement facilities such as arcade game machine, transmission of high quality animation or three-dimensional image, equipment internal wiring of e.g. computers of automatic switchboards, general indoor communication network, various sensors, lighting, illumination and energy transmission.

Now, the present invention will be explained in further detail with reference to Examples. However, needless to say, the present invention is by no means restricted to such specific examples.

### EXAMPLE 1

As a low refractive index fluoropolymer (a), a cyclic polymerization product (refractive index 1.34) of perfluoro(3-oxa-1,6-heptadiene) was selected, and a columnar island preform (c) having an outer diameter of 20 mm and a length of 500 mm was formed. On the other hand, 15 mass % of a CTFE (chlorotrifluoroethylene) oligomer was added to the above cyclic polymerization product of perfluoro(3-oxa-1,6-heptadiene) and diffused under heating to prepare a fluoropolymer as a high refractive index component (refractive index: 1.355), and a hollow tube (sea preform: d) having an outer diameter of 40 mm, an inner diameter of 21 mm and a length of 550 mm and a solid rod having an outer diameter of 20 mm were formed. The solid rod alone was subjected to melt spinning to obtain a strand (e) having an outer diameter of 0.5 mm.

The island preform (c) was inserted into the hollow portion of the hollow tube (sea preform: d), followed by melt spinning in a heating furnace heated at 220° C. to obtain a strand (f) having an outer diameter of 0.5 mm and a diameter of the island of 0.25 mm.

Further, by using the cyclic polymerization product of perfluoro(3-oxa-1,6-heptadiene), a hollow tube (g) having an outer diameter of 20 mm, an inner diameter of 10 mm and a length of 500 mm was molded by rotational molding. At the hollow portion of the hollow tube (g), the strand (e) prepared by the high refractive index fluorine-containing compound was disposed at the center portion, and 200 strands (f) prepared by the low refractive index fluoropolymer and cut into a length of 480 mm were inserted concentrically to surround the strand (e), to prepare a preform (h).

The preform (h) was subjected to melt spinning in a heating furnace heated at 220° C. to obtain an optical fiber 1 made of fluoropolymers, having an outer diameter of 0.5 mm and having a sea and islands structure in which 200 strands of a dispersed phase (island material) 3 having a diameter of 6 μm, made of a low refractive index fluorine-containing compound, were dispersed in a continuous phase (sea material) 2 made of a high refractive index fluorine-containing compound, as shown in FIG. 5. In the optical fiber as shown in FIG. 5, the strands of the dispersed phase 3 are linearly arranged each from the center towards the outside in vertical and horizontal directions and in oblique directions so as to divide the continuous phase 2 into six, and between the linearly arranged strands of the dispersed phase 3, strands of the dispersed phase 3 are dispersed with periodicity to a certain extent. A laser light with NA (numerical aperture) of 0.1 at a wavelength of 850 nm was made to enter the obtained optical fiber 1 made of fluoropolymers to carry out a transmission test for 200 m, and as a result, the attenuation was 19 dB/km and the bandwidth was 4 GHz·km. Further, the loss was at most 0.01 dB when the optical fiber was bent at an angle of 180° with R (curvature) 10.

### EXAMPLE 2

As a low refractive index fluoropolymer (a), a copolymer of perfluoro(2,2-dimethyl-1,3-dioxol) [PDD] and tetrafluoroethylene [TFE] (mol percent ratio 65:35) (refractive index: 1.31) was selected, and a solid rod having an outer diameter of 20 mm and a length of 300 mm was prepared. The solid rod (j) was subjected to spinning by heating to obtain a strand (k) having an outer diameter of 2 mm.

Further, in a tube made of a perfluoro(alkyl vinyl ether)/tetrafluoroethylene type copolymer (PFA) having an inner diameter of 40 mm, 30 bars made of a polycarbonate, having an outer diameter of 2 mm and a length of 300 mm, were evenly arranged to form concentric circles (that is, no bar was disposed at the center of the concentric circles), and in such a case, a cyclic polymerization product (refractive index 1.34) of perfluoro(3-oxa-1,6-heptadiene) as a high refractive index fluoropolymer (a) for sea material in a molten state was injected into the tube, to obtain a sea material precursor (1). After solidification by cooling, the sea material precursor (1) was immersed in a dimethyl chloride solvent. In the structure of the sea material precursor (1), the fluoropolymer (a) was not eroded at all, and the bars made of a polycarbonate alone were dissolved.

As a result, a sea material (m) having an outer diameter of 40 mm and a length of 300 mm, and 30 through holes having an inner diameter of 2 mm formed to form concentric circles with a diameter of 20 mm, was obtained.

Into each through hole of the obtained sea material (m), one strand of the island material obtained by cutting a strand (k) made of a low refractive index fluorine-containing compound into a length of 300 mm was inserted. The sea material (m) and the strands of the island material (k) were integrated at the bottom to prevent slippage, followed by melt spinning at 240° C.

As a result, an optical fiber 1 made of fluoropolymers, having an outer diameter of 0.5 mm and having a sea and islands structure in which 30 strands of the dispersed phase (island material) (diameter 25 μm) 3 made of a low refractive index fluorine-containing compound were dispersed in a continuous phase (sea material) 2 made of a high refractive index fluorine-containing compound, as shown in FIG. 6, was obtained. In the optical fiber 1 as shown in FIG. 6, the strands of the dispersed phase 3 are arranged periodically to a certain extent-concentrically relative to the center axis of the optical fiber 1. A laser light with NA of 0.25 at a wavelength of 1,300 nm was made to enter the obtained optical fiber to carry out a transmission test for 500 m, and as a result, the attenuation was 17 dB/km and the bandwidth was 1 GHz·km. Further, the loss was 0.1 dB when the optical fiber was bent at an angle of 180° with R10.

### EXAMPLE 3

As a fluoropolymer (a), a cyclic polymerization product (refractive index 1.34) of perfluoro(3-oxa-1,6-heptadiene) was selected, and a columnar body having an outer diameter of 20 mm and a length of 500 mm was formed. 7 mass % of perfluorotriphenylbenzene (TPB) was added thereto, followed by mixing under heating at 250° C. to prepare a high refractive index (refractive index: 1.355) fluorine-containing compound, and a sea preform (n) having an outer diameter of 40 mm and a length of 500 mm was prepared.

Further, the cyclic polymerization product of perfluoro(3-oxa-1,6-heptadiene) was employed as it is to obtain a low refractive index (refractive index: 1.34) fluoropolymer, and a columnar body (o) for island preform having an outer diameter of 20 mm and a length of 550 mm was formed in a metal tube.

Two corrosion resistant 20 mm screw extruders were prepared, and an extruder 1 which supplies the island preform and an extruder 2 which supplies the sea preform around the periphery thereof, were connected by means of a crosshead. It is constituted such that the sea preform is split into 19 strands in the crosshead, and the sea preform from the extruder 2 joins around the periphery of each sea preform strand. In this structure, no island preform was supplied to the center portion. At the tip of the crosshead, a nozzle with a diameter of 3 mm was formed.

The island preform (o) was charged in the extruder 1 and melted at 200° C. At the same time, the columnar body (n) for sea preform was charged into the extruder 2 and melted at 220° C. They met in the crosshead and led to the nozzle in a multiple layered cross section wherein 19 strands of the island preform were dispersed as a dispersed phase in the sea preform as a continuous phase. The multiple layered molten resin (p) extruded to the outside by means of the nozzle was stretched to an outer diameter of 0.5 mm to obtain a plastic optical fiber as shown in FIG. 3. The optical fiber 1 as shown in FIG. 3 had a sea and islands structure in which strands of the dispersed phase 3 (island material) having a diameter of 40 μm were periodically dispersed concentrically relative to the center axis of the optical fiber 1 in the continuous phase (sea material) 2. A laser light with NA of 0.25 at a wavelength of 850 nm was made to enter the obtained optical fiber to carry out transmission test for 1,000 m, and as a result, the attenuation was 25 db/km and the bandwidth was 1.2 GHz·km. Further, the loss was 0.2 dB when the optical fiber was bent at an angle of 180° with R10.

### EXAMPLE 4

As a low refractive index fluoropolymer (a), a copolymer of perfluoro(2,2-dimethyl-1,3-dioxol) [PDD]/tetrafluoroethylene [TFE](mol percent ratio 65:35) (refractive index: 1.31) was selected as an island preform, and as a high refractive index fluoropolymer, perfluoro(3-oxa-1,6-heptadiene) (refractive index: 1.34) was selected as a sea preform. Each was melted at 260° C. and solidified in a metal tube having an inner diameter of 20 mm to form a columnar body having an outer diameter of 40 mm and a length of 500 mm.

Two corrosion resistant 15 mm plunger extruders were prepared, and an extruder (1) which supplies the island preform and an extruder (2) which supplies the sea preform around the periphery thereof, were connected by means of a crosshead. It is constituted such that the island preform is split into two strands in the crosshead, and each strand is further split into 100 strands, and then the sea preform from the extruder (2) joins around the periphery of each island preform strand. In this structure, the sea preform is disposed at the center portion of each assembly consisting of 100 island preform strands. At the tip of the crosshead, a nozzle having an elliptic cross section of 3 mm×5 mm was provided.

The island preform was introduced into the extruder (1) and melted at 220° C. At the same time, the columnar body for sea preform was introduced into the extruder (2) and melted at 250° C.

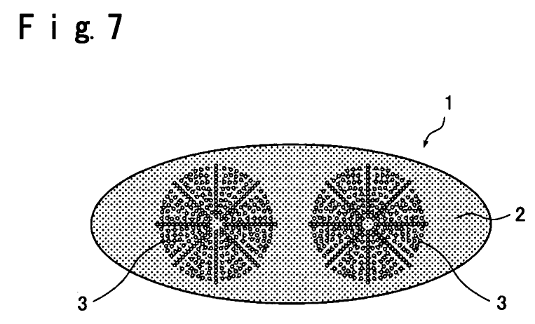

They met in the crosshead and led to the nozzle in a multiple layered cross section wherein the island preform forming two assemblies, each consisting of 100 island preform strands, were dispersed in the sea preform as a continuous phase so that each assembly forms concentrical circles. The multiple layered molten resin (o) extruded to the outside by means of the nozzle was stretched to an outer diameter of 0.3×0.5 mm, and a single mode duplex (bidirectional) plastic optical-fiber having a sea and islands structure in which 100 starnds of the dispersed phase (island material) 3 were present in one assembly, each strand of the dispersed phase (island material) 3 having a diameter of 3 μm, as shown in FIG. 7, was obtained. As shown in FIG. 7, the obtained optical fiber 1 has an elliptic cross sectional shape, and has two assemblies of the dispersed phase (island material) 3 arranged concentrically relative to the axis direction of the optical fiber 1 in the continuous phase (sea material) 2. A laser light with NA of 0.1 at a wavelength of 850 nm was made to enter the obtained optical fiber to carry out a transmission test for 200 m, and as a result, the attenuation was 25 dB/km and the bandwidth was 4.0 GHz·km. Further, by using this optical fiber, bidirectional transmission could be carried out with one fiber. The loss was at most 0.01 dB when the optical fiber was bent at an angle of 180° with R10.

### EXAMPLE 5

As a fluoropolymer (a), perfluoro(4-methyl-butenyl vinyl ether) which is a low refractive index fluoropolymer (refractive index: 1.328) was selected as an island preform, and perfluoro(3-oxa-1,6-heptadiene) which is a high refractive index fluoropolymer (refractive index: 1.34) was selected as a sea preform. Each was melted at 250° C. and solidified in a metal tube having an inner diameter of 20 mm to form a columnar body having an outer diameter of 30 mm and a length of 500 mm.

Two corrosion resistant 15 mm plunger extruders were prepared, and an extruder (1) which supplies the island preform and an extruder (2) which supplies the sea preform around the periphery thereof, were connected by means of a crosshead. It is constituted such that the island preform is split into two strands in the crosshead, and each strand is further split into 100 strands, and then the sea preform from the extruder (2) joins around the periphery of each island preform strand. In this structure, the sea preform is disposed at the center portion of each assembly consisting of 100 island preform strands. At the tip of the crosshead, a nozzle having an elliptic cross section of 3 mm×5 mm was provided.

The island preform was introduced into the extruder (1) and melted at 220° C. At the same time, the columnar is body for sea preform was introduced into the extruder (2) and melted at 250° C.

They met in the crosshead and led to the nozzle in a multiple layered cross section wherein the island preform forming two assemblies, each consisting of 100 island preform strands, were dispersed in the sea preform as a continuous phase so that each assembly forms concentrical circles. The multiple layered molten resin (o) extruded to the outside by means of the nozzle was stretched to an outer diameter of 0.3×0.5 mm, and a single mode duplex (bidirectional) plastic optical fiber having a sea and islands structure in which each strand of the dispersed phase (island material) has a diameter of 3 μm, as shown in FIG. 7, was obtained. The obtained optical fiber 1 as shown in FIG. 7 has an elliptic cross sectional shape, and has two assemblies of the dispersed phase (island material) 3 arranged concentrically relative to the axis direction of the optical fiber 1 in the continuous phase 2. A laser light with NA of 0.1 at a wavelength of 850 nm was made to enter the obtained optical fiber to carry out a transmission test for 200 m, and as a result, the attenuation was 25 dB/km and the bandwidth was 4.0 GHz·km. Further, by using this optical fiber, bidirectional transmission could be carried out with one fiber. The loss was at most 0.01 dB when the optical fiber was bent at an angle of 180° with R10.

Industrial Applicability

The present invention provides an optical fiber product which has a low attenuation, mechanical strength, heat resistance, moisture resistance, chemical resistance and incombustibility required for LAN, housing complexes, medical equipments, automobiles, office automation and electric household appliances, which has not been achieved with a conventional plastic optical transmission article of e.g. a polymethyl methacrylate type, a polystyrene type or a polycarbonate type. Further, it provides a low attenuation and high bandwidth type optical fiber product having a sea and islands structure, with which visible light (500 to 700 nm) and near infrared light (700 to 1,600 nm) can be utilized, which has not been achieved with a conventional optical transmission article, of which the bending loss is decreased when bent, since it is an optical fiber having a sea and islands structure, and which can impart ultra-high speed transmission properties by employing single mode transmission conditions as the case requires.

The entire disclosure of Japanese Patent Application No. 2002-251098 filed on Aug. 29, 2002 including specification, claims, drawings and summary is incorporated herein by reference in its entirety.

1. An optical transmission article which has a sea and islands structure in which a low refractive index dispersed phase is dispersed in a high refractive index continuous phase.

2. The optical transmission article according to claim 1, wherein in the cross sectional shape of the optical transmission article, the low refractive index dispersed phase is arranged to have a periodicity forming an optical waveguide.

3. The optical transmission article according to claim 1, wherein each of a component constituting the high refractive index continuous phase and a component constituting the low refractive index dispersed phase is made of a polymer of an organic compound.

4. The optical transmission article according to claim 3, wherein the component constituting the high refractive index continuous phase is made of an amorphous fluoropolymer (a) having substantially no C—H bond, and the component constituting the low refractive index dispersed phase is made of a fluoropolymer (b) having a refractive index lower than the fluoropolymer (a) by at least 0.001.

5. The optical transmission article according to claim 4, wherein the fluoropolymer (a) contains a fluorinated cyclic structure.

6. The optical transmission article according to claim 5, wherein the fluorinated cyclic structure is a fluorinated alicyclic structure which may contain a ring member ether bond.

7. The optical transmission article according to claim 5, wherein the fluoropolymer containing a fluorinated cyclic structure has the fluorinated cyclic structure in its main chain.

8. The optical transmission article according to claim 4, wherein each of the fluoropolymers (a) and (b) is an amorphous fluoropolymer having substantially no C—H bond and having a fluorinated alicyclic structure which may contain an ether bond in its main chain.

9. A preform to be used for producing the optical transmission article as defined in claim 3, which has a sea and islands structure in which a polymer of an organic compound as a low refractive index component is dispersed in a continuous body made of a polymer of an organic compound as a high refractive index component, and the polymer of an organic compound as a low refractive index component extends in the longitudinal direction in the continuous body.

10. A method for producing the optical transmission article having a sea and islands structure as defined in claim 3 or its perform, which comprises disposing a polymer of an organic compound as a low refractive index component in the form of a preliminarily divided strand, in a tube made of a polymer of an organic compound as a high refractive index component, followed by co-spinning.

11. A method for producing the optical transmission article having a sea and islands structure as defined in claim 3 or its perform, which comprises splitting and forming into strands in an extrusion die a uniformly molten polymer of an organic compound as a low refractive index component, supplying an organic compound polymer as a high refractive index component around the periphery thereof, so that the polymer of an organic compound as a high refractive index component is applied around the outer periphery of the polymer of an organic compound as a low refractive index component, and extruding them through a common nozzle.

12. An optical fiber cord comprising the optical transmission article as defined in claim 1 and at least one covering applied on the optical transmission article.

13. An optical fiber cable comprising a continuous body made of a thermoplastic resin, having pores extending in the longitudinal direction in the inside thereof and having a tension member embedded therein, and the optical fiber cord as defined in claim 12 accommodated in the pores in the continuous body.

14. A bundled fiber having a plurality of the optical fiber cords as defined in claim 12 bundled.
